(19) United States
(12) Patent Application Publication
(10) Pub. No.: US 2026/0251200 A1
(43) Pub. Date: Aug. 27, 2026

(54) SQUEEZE FILM DAMPER

(71) Applicants: Innomotics GmbH, 90441 Nürnberg (DE); Gleitlagertechnik Weissbacher GmbH, 46519 Alpen (DE)

(72) Inventors: CHRISTOPH WEISSBACHER, Duisburg (DE); MARTIN WIESCHALLA, Berlin (DE)

(73) Assignees: Innomotics GmbH, 90441 Nürnberg (DE); Gleitlagertechnik Weissbacher GmbH, 46519 Alpen (DE)

(21) Appl. No.: 19/165,744

(22) PCT Filed: Mar. 15, 2024
(86) PCT No.: PCT/EP2024/057005

§ 371 Date: Sep. 16, 2025

(30) Foreign Application Priority Data
Mar. 17, 2023 (EP) 23162628.4

(51) Int. Cl. F16F 15/023; F16C 27/02; H02K 5/167; H02K 5/24

(52) U.S. Cl. CPC F16F 15/0237; F16C 27/02; H02K 5/167; F16C 2380/26; H02K 5/24

(57) ABSTRACT

A squeeze film damper includes an inner ring, an outer ring, and a plurality of bars designed to connect the inner ring and the outer ring. At least one of the inner and outer rings includes a flange, with individual ones of the plurality of bars being connected only to the flange.

The invention relates to a squeeze film damper and to a method for creating and for operating a squeeze film damper, the squeeze film damper being used, in particular, in a bearing.

Squeeze film dampers are employed in electric machines, for instance. Electric machines are, for instance, motors or generators. By means of a squeeze film damper—which comes into operation, in particular, in interaction with a bearing of the electric machine—the rotor-dynamics design of a rotating electric machine can be influenced. Particularly in the case of machines rotating at high speed—that is to say, electric machines rotating at high speed, such as high-speed motors—the occurrence of natural frequencies of the rotor-bearing system within the operating range has to be reckoned with in the context of the rotor-dynamics design of the machine, and these natural frequencies have to be taken into account, which may lead to restrictions in the operation of the machines, since operation at, or close to, natural frequencies potentially gives rise to large vibration amplitudes, this, in tum, being generally undesirable due to standardization or by reason of the operational-safety aspects to be guaranteed. If vibrations cannot be prevented or damped sufficiently, the machines are only capable of being utilized within a restricted range of operating speeds. The rotor-dynamics design is undertaken, for instance, in a manner specific to the requirements as regards the operating-speed range from a specific project or application. If this operating-speed range is to be adapted (shifted or extended), a renewed tuning of the dynamic system consisting of rotor, slide bearing and support is required. This is associated with great expenditure in terms of time and resources, and such expenditure has to be incurred at the time of tendering, considerably prolonging the period for processing the tender, and being disadvantageous. In addition, a rotor-bearing system of an electric machine with a rotor and with a stator, for example, is not capable of being optimized with conventional slide bearings to the extent that great robustness with respect to changes of the operating-speed range can be achieved. The consequence of this may be additional project-specific and/or application-specific design cycles. The rotor-bearing system can be improved with a squeeze film damper. The bearing is, for instance, a ball bearing or a slide bearing.

Known from U.S. Pat. No. 4,453,783 A is a bearing support structure in which the outer bearing ring is located in a supporting ring which is surrounded by an outer damper ring, in order to form an oil-damper space in between them. Located at one end of the supporting ring is a protruding flange to which one end of a ring consisting of rods has been respectively fastened. This ring of rods surrounds the outer damper ring and has been fastened at the other end of the rods to the remote end of the outer damper ring. The inner end of the damper ring is borne by a fastening flange by means of a frustoconical element which exhibits through-holes for the bars,

Known from U.S. Pat. No. 9,890,810 B2 is a squeeze film damper which includes a bearing housing as an inner ring which is arranged around a radially outer side of a bearing which supports a rotary shaft in rotatable manner. Furthermore, there is an outer ring which is arranged around a radially outer side of the bearing housing, a squeeze film, which is formed by circulating a viscous material, with fluid through an interspace in a radial direction between the bearing housing and the outer ring, and a coupling pin which couples the bearing housing and the outer ring with one another. The coupling pin has a rigidity that is higher in a vertical direction than in a horizontal direction in a cross-section perpendicular to an axial direction of the rotary shaft.

An object of the invention is to improve a squeeze film damper.

A solution achieving this object arises in the case of a squeeze film damper as claimed in claim 1 and in the case of an electric machine as claimed in claim 14 and in the case of a method as claimed in claim 15. Further configurations arise as claimed in claims 2 to 13, 16 and 17, for instance. Features of these configurations, and of further configurations and examples described in the following, can also be combined with one another.

A squeeze film damper exhibits an inner ring and an outer ring, wherein the inner ring and the outer ring have been connected by means of bars, wherein at least one of the rings—that is to say, in particular, the inner ring or the outer ring—exhibits a flange, wherein individual bars have been connected, In particular, only to a flange. Accordingly, an axially compact structural design, for instance, is possible. It is also possible, for instance, to transmit axial forces, The bars each take the form, in particular, of a resilient element—that is to say, in particular, a bar spring. The bar has, in particular, a round or oval cross-section.

In one configuration of the squeeze film damper, different bars or groups of bars, which, In particular, succeed one another in a circumferential direction, have been alternately connected to different flanges, in particular on different end faces of the squeeze film damper or, to be more exact, of the inner ring or of the outer ring, the connection of a bar being made in each instance, in particular, only to a flange. This means that on one side of the bar the connection is made to a flange, and on the other side of the bar the connection is made to a flange-free end face. For instance, one end of a bar has been positioned on one end face on a flange of one of the rings, and the other end of the bar has been positioned on an opposing end face in a flange gap of the further ring on the end face thereof.

In one configuration of the squeeze film damper, the latter has been integrated into a bearing in interleaved manner. The inner ring and the outer ring have, wholly or predominantly, the same axial position.

In one configuration of the squeeze film damper:
the inner ring and the outer ring or
only the inner ring or
only the outer ring
   exhibit(s) a flange. The flange or flanges have/has been designed, in particular, to be toothed. Individual bars have been connected to only one of the flanges. In particular, the squeeze film damper exhibits axially aligned bars arranged in the form of a circle, with at least some bars positioned side by side having been connected to different flanges.

The connection of the bars, or of the bar, concerns, in particular, one of the end regions of the bar. One end region of a bar exhibits, for instance, a thread onto which a screw is capable of being screwed. A further end region of a bar exhibits, for Instance, a head as a stop. Between the end regions of a bar, the latter exhibits, in particular, no thread—that is to say, between the end regions it is free of a thread.

In one configuration, a squeeze film damper which exhibits an inner ring and an outer ring has a form in which the inner ring and the outer ring have been axially positioned relative to one another by means of bars. “Axially positioned relative to one another by means of bars” signifies, in particular, an independent positioning. A bar is, in particular, a structural part which has a round, angular, oval or other cross-section. The one bar, or the plurality of bars, takes/take the form, in particular, of a bar spring, or bar springs. Bar springs are, in particular, structural parts having elastic properties which are utilized for a spring action. In the case of a fixed axial positioning of inner ring relative to outer ring, axial forces can be transmitted in this way. “Axial” in this connection means along an axis and/or in the direction of an axis. The axis in this connection is, in particular, the axis of a bearing, or an axis of rotation. The bars exhibit, in particular, a thread. The thread is, in particular, in a region of the bar, or of the respective bars, that in operation is free from an alternating mechanical stress—that is to say, in particular, free from a spring action. The bars have been passed, in particular, through recesses in the outer ring,

In particular, the inner ring and also the outer ring exhibit end faces. The bars are axially aligned and exhibit end regions. A first end region of a bar is, for instance, an end head, and a second end region exhibits, for instance, a thread, in which case a screw has been screwed onto the thread. A bar may, for instance, also exhibit on each end region a thread with a screw.

In one configuration of the squeeze film damper, a first end region of a bar, or of a plurality of bars, has been connected to the inner ring on one end side, the second end region of this bar having been connected to the outer ring. On one axial end face, a bar accordingly bears with its one end region against the inner ring, and on the further axial end face bears with its further end region against the outer ring. This can be provided for a plurality of bars.

In one configuration of the squeeze film damper, on one end face individual bars, or successive groups of bars, have been connected alternately to the inner ring or to the outer ring.

In one configuration of the squeeze film damper, the inner ring and the outer ring are capable of being braced relative to one another-that is to say, in particular, they have been braced relative to one another and/or are capable of being variably positioned. The variable positionability concerns the positioning of inner ring and outer ring relative to one another. This positioning concerns, for instance, an axial positioning and/or a radial positioning. In the case of a squeeze film damper, the inner ring and the outer ring may therefore have been braced, or may be braced, relative to one another, and/or may have been variably positioned, or may be variably positioned. The bracing and/or positioning are/is obtained, in particular, by means of an Interleaving of elements for bracing and/or positioning. The inner ring or the outer ring can, in particular, accommodate a bearing, the bearing being, in particular, a bearing of an electric machine. The electric machine is, for instance, an electric machine rotating at high speed with a rotational speed from 1000 rpm to 30,000 rpm. By virtue of the possibility of bracing or positioning, it is possible to adapt an operating-speed range of a machine (an electric machine). If the operating-speed range is to be adapted (shifted or extended), a renewed tuning of the dynamic system consisting of rotor, slide bearing and support is required. This can now be done by changing the bracing and/or positioning. Once the inner ring and the outer ring have been positioned relative to one another, this position may have been put into effect in such a manner that the rings are stress-free relative to one another or have been braced relative to one another.

In one configuration of the squeeze film damper, bars have been provided for connecting the inner ring to the outer ring, the inner ring having been braced, or being capable of being braced, in particular axially, relative to the outer ring by means of the bars, and/or having been variably positioned, or being capable of being variably positioned. Different and/or identical bars may, for instance, have a different and/or identical cross-section. Cross-sections are, for instance, round, angular or oval. By virtue of the bars, a spring action may arise. A bar is accordingly a type of spring element and may consequently also be designated as a spring bar or as a spring element. In addition, a bar is, in particular, an element for obtaining a bracing or positioning, in particular an interleaved bracing or positioning, of inner ring and outer ring. In the case of a prestressing of the bars, they are, in particular, subjected to tension, or prestressed. Hence the rigidity of the connection between inner ring and outer ring of the squeeze film damper can be changed.

In one configuration of the squeeze film damper, the inner ring and/or the outer ring are/is an open ring and/or a closed ring, in which connection open rings, in particular, are capable of being joined together to form a closed ring. The squeeze film damper has accordingly been segmented into two half-rings, for instance. These segments can be joined together to form a closed ring. The segments have, for instance, been screw-coupled together. By virtue of the segmentation, it is possible, for instance, to integrate a bearing into the squeeze film damper. The squeeze film damper includes the bearing, for instance entirely or partly, which, for instance, is a slide bearing or a roller bearing. The squeeze film damper may, for instance, have been positioned together with the bearing in a bearing housing. In such a configuration, the squeeze film damper becomes part of a bearing. The invention therefore relates in general not only to a squeeze film damper but also to a bearing (for example, a roller bearing or a slide bearing) with a squeeze film damper,

In one configuration of the squeeze film damper, the inner ring and/or the outer ring are/is capable of being divided, or have/has been divided. Hence, in particular, an integration into a bearing, and/or the connection to a bearing, can be structurally facilitated. The inner ring or the outer ring may exhibit a lower partial circle and an upper partial circle, the lower and upper partial circles forming a complete circle when joined together. The lower partial circle is the part that faces toward a mounting of the bearing, or of the bearing housing, or of the electric machine, on a foundation (this is an example of a support or substructure) or such like. The upper partial circle is correspondingly the part facing away from such a mounting.

In one configuration of the squeeze film damper, a first number of bars have been provided for the purpose of being able to pull the outer ring in a first axial direction of tension, and a second number of bars have been provided for the purpose of being able to pull the outer ring in a second axial direction of tension, in which case bars and/or groups of bars having different potential directions of tension alternate. By virtue of this alternating, an interleaving arises. The directions of tension are, in particular, opposed and, in addition, axially parallel to an axis of rotation of the electric motor, or axially parallel to the axis of rotation of the bearing. With their spring action, the bars may form a type of spring cage. The bars may furthermore have been positioned in the form of a circle and axially parallel to the bearing axis. Accordingly, it is possible to realize a squeeze film damper with interleaved spring cage with prestressed spring elements and/or with variable stiffness, in which case this damper has been integrated, in particular with its structural design, into a bearing housing, or surrounds a bearing, integrated like a slide bearing-that is to say, in particular, entirely or partly. By virtue of the interleaving of the connection between inner ring and outer ring, it is possible to realize slight internal constraint forces and therefore a radial guidance, as ideal as possible, of the rings relative to one another without tilting. Different, at least potential, directions of tension between inner ring and outer ring, which are obtained by virtue of the interleaving, can prevent a tilting of inner ring relative to outer ring. A transmission of axial forces is possible, in particular in interlocking manner.

In one configuration of the squeeze film damper, the bars exhibit a surface layer, this surface layer resulting from a surface coating and/or from a surface treatment. The surface layer arises, for instance, by virtue of a nitrocarburizing of a parent substance for the bar, consisting of the material 42CrMo4. This ensures a sufficient corrosion resistance in the event of repeated joining of bar and rings-that is to say, of the outer ring and the inner ring.

In one configuration of the squeeze film damper, the bars exhibit different materials.

In one configuration of the squeeze film damper, the bars exhibit a material with higher bending fatigue strength than the material that finds application for the purpose of forming the rings.

In one configuration of the squeeze film damper, the inner ring has a U-shaped profile, with the outer ring protruding at least partly into the profile. In a further configuration of the squeeze film damper, the outer ring has a U-shaped profile, with the inner ring protruding at least partly into the profile. The profile results from successive cross-sections. A first cross-section of a ring has, for example, a first L-shape, and a subsequent, second cross-section of the ring has a mirror-image, second L-shape. By virtue of the mirroring, a U-shape accordingly results from, practically, two L-shapes placed on top of one another. The U-shape of a ring does not necessarily arise by virtue of a single cross-section, but rather by virtue of a view of successive cross-sections of a ring against one another in a kind of shadow-casting. This sequence of the different cross-sections makes the interleaving possible.

In this way, a compact structural design can be achieved. Furthermore, in this way a bracing, and also a positioning, of inner ring relative to outer ring, or conversely, is possible in straightforward manner.

In one embodiment, the inner ring exhibits, in particular, axial end faces. On each end face the inner ring exhibits a toothed flange. The tooth system is directed radially outward. The individual teeth are distributed over the circumference of the circular flange. By virtue of the tooth system, the L-shaped cross-section of a ring may arise. The tooth system on one of the end faces is offset in its circular position relative to the tooth system on the other end face. The tooth system exhibits holes, a bar having been passed into each hole. The bar has furthermore been passed through a hole in the outer ring. The outer ring exhibits a plurality of holes for the passage of bars, the holes extending axially in parallel. By virtue of the fact that the tooth systems on the end faces are offset, in regions of the tooth system on a first end face the inner ring is pulled, or positioned, toward the outer ring, or conversely, by means of the bars in a first axial direction. And similarly by virtue of the fact that the tooth systems on the end faces are offset, in regions of the tooth systems on the second end face the inner ring is pulled, or positioned, toward the outer ring, or conversely, by means of the bars in a second axial direction which is contrary to the first axial direction. Hence an interleaving is obtained, and also, in particular, a bracing of inner ring relative to outer ring.

In one configuration, individual bars or groups of bars can be inserted, or may have been inserted, alternately from the left and from the right (that is to say, in each instance from the other end face) into the inner ring and/or the outer ring. By virtue of this alternating arrangement, an interleaved spring cage has been formed. The outer ring may accordingly be braced, or positioned, with respect to the inner ring, since the outer ring is alternately pulled, or positioned, in axially parallel manner in opposite directions over sectors of a circle (partial circles). The positioning, in particular the axial positioning, can be undertaken variably, since the effective length of the bars can be shortened or lengthened by means of nuts if the bars take the form of screws. In one configuration of bars that have a spring action, the bar has a spring-effective length, the spring-effective length remaining the same regardless of the position-dependent effective length of the bar.

In one configuration of the squeeze film damper, the bearing is encompassed by the squeeze film damper. The bearing, which, in particular, is a slide bearing, may have been, for instance, screw-coupled with the inner ring or pressed into it, or may have been integrated into it.

In one configuration of the squeeze film damper, a bearing has accordingly been provided therein, the bearing being, in particular, a slide bearing, and the bearing supporting, in particular, the rotor of an electric machine.

In one configuration of the squeeze film damper, the squeeze film damper has been integrated, or is capable of being integrated, into a bearing housing. Hence a compact structural design can be realized.

In one configuration of the squeeze film damper, the bracing and/or positioning of inner ring and outer ring is capable of being adapted. This is done, for instance, by the tension on the bars being changed, or by the effective length of the bars being changed. If the bars exhibit a screw connection, for instance, the tension on the screw can be changed. In a further configuration, for the purpose of adapting the bracing different bars can also be used, or one or more bars can be replaced by (exchanged for) one or other bars which, in particular, exhibit a different material and/or a different shape. For instance, a different cross-section in shape or size can be chosen for the bar or bars,

In one configuration of the squeeze film damper, at least one bar is capable of being exchanged, and/or one bar has at least a different spring action. As a result, the frequency response of an electric machine, for instance, can be influenced positively, since the frequency range within which no natural vibrations arise can be enlarged or adapted.

An electric machine, such as a synchronous machine or an asynchronous machine, exhibits, in particular, a first bearing and a second bearing. The first bearing is, for instance, on a drive side of the electric machine which is, in particular, a motor or a generator, and the second bearing is, for instance, on an operating side of the electric machine. At least one of the bearings exhibits a squeeze film damper or has been combined therewith and/or connected thereto. The squeeze film damper exhibits one of the embodiments or features of the squeeze film damper described herein.

According to a method for creating a squeeze film damper, elements of the squeeze film damper are braced and/or variably positioned, a first element being an inner ring, and a second element being an outer ring. Bars can be used for the purpose of bracing or positioning. For the purpose of changing the bracing, the tensile loading of the bars can be changed. Moreover, bars can be exchanged for the purpose of changing the bracing, with the new bars differing from the exchanged bars. The difference concerns, in particular, the spring properties of the respective exchanged bar. For the purpose of positioning, the effective length of a bar can be changed.

In one configuration of the method, for the purpose of changing a spring action and/or a position at least one bar is accordingly exchanged, and/or a prestressing is changed at least in the case of one bar, and/or an effective length of a bar is changed. In the case of a design as a type of screw, the effective length of a bar is determined by the position of a nut. Portions of the bar that protrude beyond the nut are not effective.

In one configuration of the method, use is made of a squeeze film damper of one of the described types.

By virtue of the squeeze film damper described, a hydrodynamic slide bearing, for instance, can be retained or improved. Bearing arrangements of such a type find application in electric machines, for Instance. The hydrodynamic slide-bearing arrangement is retained or supplemented as a type of bearing arrangement between rotating and stationary components of a system such as an electric machine. In addition, a further bearing, the squeeze film damper, is inserted into the stationary components. The squeeze film damper can accordingly be understood as a bearing arrangement of a bearing, namely a rotating bearing, for an electric machine. By means of the squeeze film damper described, an improved decoupling of a rotor-bearing system from the support-that is to say, for example, from the foundation for installing the electric machine- and a diminution of the Influence of the oil-film coefficients can be obtained. Besides a foundation, a machine frame, a machine housing, etc., are examples of a support.

When conventional slide bearings are being employed, the natural frequencies of the rotor-bearing system depend crucially on the speed-dependent oil-film coefficients. When a squeeze film damper is being additionally employed, the rotor support is made considerably softer, by virtue of which only a weak coupling between rotor and support arises physically. By reason of this weak coupling, in addition the influence of the oil-film coefficients recedes into the background. The rotor behaves increasingly as in a “free-free” bearing arrangement. By virtue of this type of bearing arrangement, large intervals between the natural frequencies can be achieved which are now also independent of the operating speed and of the associated oil-film coefficients. An additional damping component and/or spring component can be introduced through the bars of the squeeze film damper. Viewed physically, the squeeze film damper can be regarded as a spring-damper system. This system additionally enables, besides the decoupling of a rotor/slide-bearing system, the damping of natural frequencies arising, and this may be beneficial to the operating behavior of rotating machines.

The use of a metallic spring cage in squeeze film dampers may necessitate an enlargement of the axial construction space. In the case of the proposed squeeze film damper, this can be avoided by virtue of the achievable small axial construction space of the squeeze film damper. In the case of the squeeze film damper described, the bars (bar springs) are inserted alternately from the left and from the right-an interleaved spring cage arises. This arrangement serves, in particular, to ensure that the bearing does not need to be made axially longer. An axially longer structural shape generally leads to a deterioration of the rotor dynamics and to greater use of material. In addition, the interleaved arrangement of the bar springs may bring about the advantageous property that a purely radial movement arises, without a tilting of the bearing carrier.

In one configuration of the squeeze film damper, and in one configuration of the method, the squeeze film damper can be centered. This constitutes a positioning. By means of a targeted prestressing of the bars (bar springs), which is generated by an offset of lower and upper partial circles, the compression of the spring cage, due to weight force, can be avoided or compensated, which may have a positive effect on the then linear properties of the squeeze film damper.

In one configuration of the squeeze film damper and in one configuration of the method, an adjustability of the spring elements-that is to say, of the bars arises, in which case the spring elements-that is to say, the bar springs-offer an increased variability in various aspects (individually or jointly):
by adaptation of their number, diameter and/or their contour, they are capable of being modified very easily as regards their stiffness, and their properties remain capable of being predicted well,
the design of the system provides, in particular by virtue of the end-face assembly, for a capacity of the bar springs for disassembly, as a result of which the advantage arises that they can be exchanged for other springs when required, or if the operating conditions of the machine have changed, or if it is possible to react to an unknown fault in the system which was not known previously,
by virtue of the design as a separate structural element capable of being disassembled, different materials (for example, spring steel, 50CrV4, 51CrV4, 100Cr6, 51CrMoV4, 100CrV4) and different manufacturing methods (for example, grinding, hardening, tempering, shot peening), which are particularly suitable for use in springs, can be used for the springs; this makes it possible to realize a better utilization of material and a smaller physical size of the springs.

With the aid of the squeeze film damper described, an enhancement of the robustness of the rotor-dynamics design of the machines can be achieved, and therefore a considerably improved range of application with, at the same time, less design effort. A space-saving arrangement of the spring cage in a standard bearing insert is possible without additional axial construction space. In particular, a variable spring stiffness in the spring cage is also possible by virtue of a capacity of the springs for disassembly and exchange,

In one configuration of the squeeze film damper, a type of spring cage has been formed by the bars, which exhibits bar springs which are arranged with their axis parallel around the rotating shaft axis. The bar springs can develop a radial stiffness and also an axial stiffness. The bars are capable of being exchanged. They can be exchanged with a customary servicing effort for the bearings, without an entire machine having to be dismantled.

In one configuration of the squeeze film damper, the latter has at least one of the following functions or features, in particular with respect to the cage, also formed by the bars:
a radial connection with adjustable stiffness of outer ring and inner ring of the squeeze film damper by means of bar springs, in particular for
   a centering of outer ring and inner ring and/or a setting of a gap that is as uniform as possible along the entire circumference by targeted prestressing of individual bar springs,
   a radial support for static and dynamic transfer of force and/or
   an axial support and/or positioning of the parts relative to one another;
bar springs mounted in inner and outer rings using means/methods for detachable connection, disassembly being facilitated by means of a chosen pairing of materials (for example, 51CrV4 and C10) and/or by means of a surface layer provided on the springs, and an additional fatigue strength of the springs having been achieved (for example, by surface hardening and/or by shot peening).

The features of the individual subject-matters and methods claimed and described are readily capable of being combined with one another. In the following, the invention will be presented and elucidated in more detail by way of example with the aid of figures. The features shown in the figures can be combined to create new embodiments without departing from the invention. Similar elements have the same reference symbols. It is shown in:

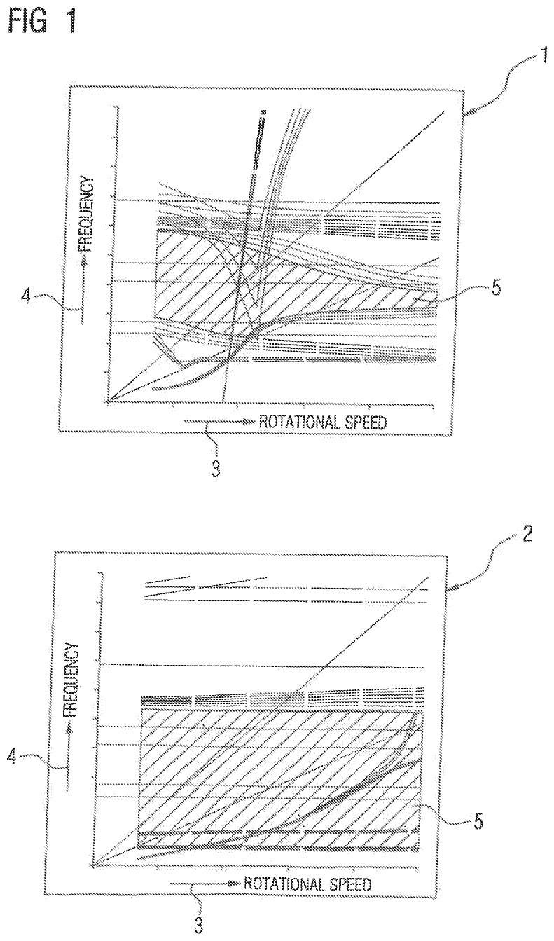

FIG. 1 two diagrams relating to frequency responses of electric machines,

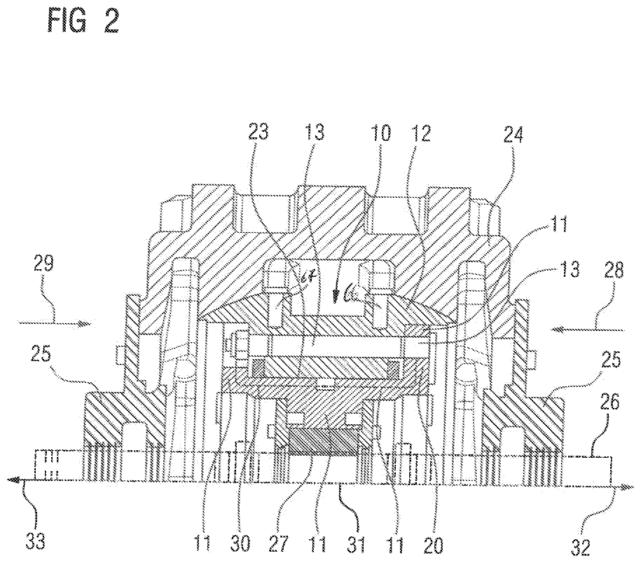

FIG. 2 a partial cross-section of a squeeze film damper in a bearing housing,

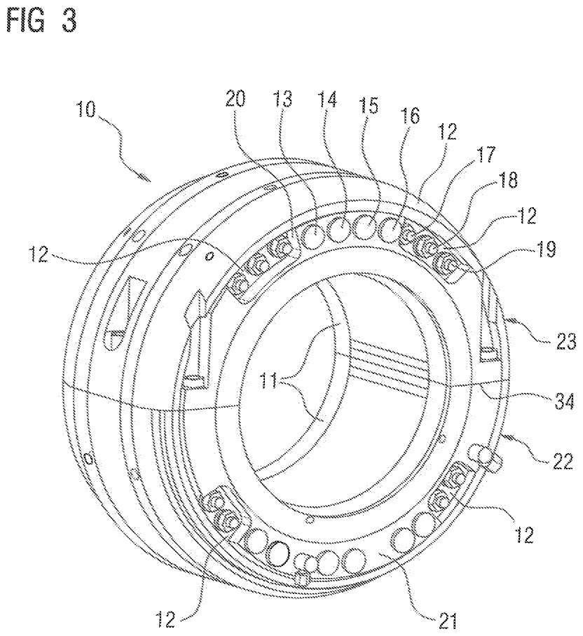

FIG. 3 a perspective representation of a squeeze film damper,

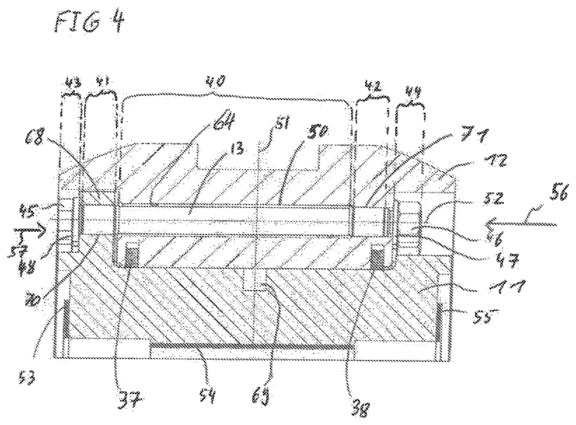

FIG. 4 a further partial cross-section of a squeeze film damper, and

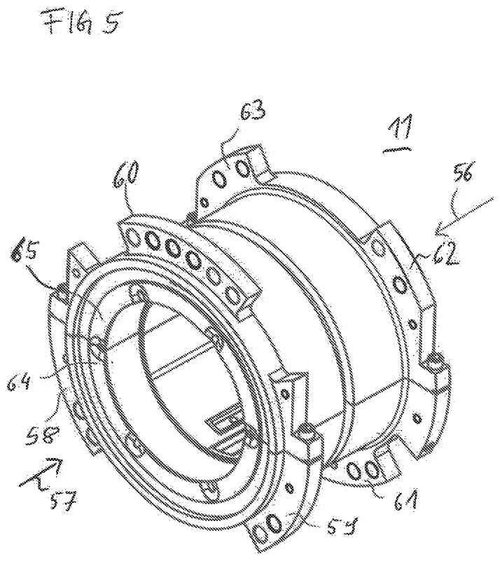

FIG. 5 a perspective representation of a two-part inner ring.

The representation according to FIG. 1 shows a first diagram 1 and a second diagram 2, both diagrams representing a frequency response over a rotational speed. The rotational speed has been plotted on an axis 3, and the frequency on an axis 4. The frequency relates to the system consisting of rotor, bearing and support (substructure). For the purpose of measuring this frequency, a sensor can be mounted on a rotor or on a bearing housing, for instance. But the frequency may also relate to a relative motion between bearing and rotor. The rotational speed relates to the revolutions of a rotor of an electric machine, or of a bearing of an electric machine. A hatched area 5 shows a range of safe behavior in each of the diagrams, so that natural frequencies are not excited. The left or upper diagram 1 relates to a system that exhibits a slide bearing. The right or lower diagram 2 relates to a system that exhibits a slide bearing with a squeeze film damper. It is apparent that through the use of the squeeze film damper the range of safe operation of the system has been increased. The system exhibits at least one electric motor with a rotor mounted in a bearing.

The representation according to FIG. 2 shows a partial cross-section of a squeeze film damper 10 in a bearing housing 24. The squeeze film damper 10 exhibits an inner ring 11 and an outer ring 12. The inner ring 11 of the squeeze film damper 10 serves as a slide-bearing carrier. The slide bearing exhibits a slide-bearing segment 27 or a plurality of slide-bearing segments. The slide bearing serves for mounting a rotor 26 or a rotor shaft of an electric machine which is not represented in any detail. The rotor shaft 26 has an axis 31, in connection with which a first axis direction 32 and a second axis direction 33 are represented. By virtue of positions of teeth, alternating on the different end faces, the inner ring 11 forms a U-shaped profile 30 into which the outer ring 12 protrudes. By virtue of the U-shaped profile 30, on the end faces 28 and 29 of the inner ring 11 opposing toothed flanges 20 are formed which are offset relative to one another in their angular position with respect to the different end faces. The respective end-face flange 20 exhibits teeth. Teeth of opposing end-face flanges are accordingly offset over an arc of a circle-that is to say, they alternate reciprocally in opposing manner over a circle. In this way, by means of a bar 13, or by means of a plurality of bars as represented in FIG. 3, the outer ring 12 can be alternately pulled in a first direction 32 toward the inner ring 11, or variably positioned, and by means of a further bar (not represented in FIG. 2) can be pulled in an opposite, second direction 33, or variably positioned. Therefore a bracing or positioning of inner ring 11 and outer ring 12 arises. A squeeze-film-damper gap 23 is located between the inner ring 11 and the outer ring 12. The bearing housing 24 is sealed with the aid of packings 25. Moreover, anti-torsion devices 66 and 67 are represented.

The representation according to FIG. 3 shows a perspective representation of a squeeze film damper 10. The squeeze film damper 10 exhibits a lower partial circle (part) 22 and an upper partial circle (part) 23. The lower part 22 has been detachably screw-coupled with the upper part 23. A bearing joint 34 has been formed between parts 11 and 12. The cage formed by the bars has accordingly been divided into two halves by the bearing joint 34. This can be utilized for easy disassembly and/or for the introduction of an offset and therefore a prestressing. The visible end-face flange of the inner ring exhibits teeth 20 and 21. By means of these teeth, such as tooth 20, bars 13, 14, 15, 16 have been guided as a group of teeth which connect the outer ring 12 to the inner ring 11. Alongside the tooth are bars 17, 18 and 19 which connect the inner ring 11 to the outer ring 12 from the other, opposing non-visible end face of the inner ring 11. The bars develop a spring action and may therefore also be designated as bar springs. The groups of bars are interleaved. The representation according to FIG. 2 and FIG. 3 shows, by way of example, a slide-bearing insert with bearing shells with an integrated squeeze film damper.

The representation according to FIG. 4 shows a further partial cross-section of a squeeze film damper. In this representation there are graphic axes 51 and 52. An outer ring 12 and an inner ring 11 are further shown. These rings are connected to one another by means of a bar 13. The inner ring 11 exhibits a flange 68. As a result, an L-shaped cross-section for the inner ring arises. Shown furthermore is a first end region 43 of the bar 13, with an end head 45 and with a head broadening 48, and a second end region 44 with a nut 46 and with a washer 47, the nut 46 having been screwed onto a thread, not represented, in the end region 44. In a seat region 41 the inner ring 11 exhibits a seat 70 for accommodating the bar 13. In a seat region 42 the outer ring 12 exhibits a seat 71 for accommodating the bar 13. A spring region 40 is located between the seat regions. In this spring region 40 the bar 13 has been accommodated in a recess 50 in the outer ring 12. The spring action of the bar 13 can develop in this spring region 40, a free space 64 having been provided for this purpose. The inner ring 11 exhibits a ring duct 69 for supplying oil. Packings 37 and 38 have been provided for the purpose of sealing. The representation further shows bearing running surfaces 53, 54 and 55 which may have been formed, in particular, in the case where use is made of a slide bearing in conjunction with the squeeze film damper. End faces are labeled with the aid of arrows 57 and 58. According to FIG. 4, arrow 57 points toward a left-side end face of the inner ring 11, and arrow 56 points toward a right-side end face of the outer ring 12. The left-side end face of the inner ring 11 according to the figure is constituted at least partly by the flange 68. From FIG. 4 it is further evident that the bar 13 connects the inner ring 11 to the outer ring 12 only via a flange. This one flange is the flange 68 of the inner ring 11.

The representation according to FIG. 5 shows, in perspective, an example of an inner ring 11, this ring being designed in two parts. The inner ring 11 exhibits a first part 64 and a second part 65. These parts have been screw-coupled together. Parts 64 and 65 are ring segments or ring-type circles. The two parts 64 and 65 constitute the inner ring 11 which exhibits a flange on both end faces. On a first end face, which is labeled by arrow 57, the flange exhibits a tooth system with teeth 58, 59 and 60. On a second end face, which is labeled by arrow 56, the further flange exhibits a tooth system with teeth 61, 62 and 63. As is apparent from FIG. 5, the teeth on one end face are offset in the circumferential direction relative to the teeth of the further end face. For instance, it has to be ensured that the connection of the inner ring to the outer ring is made via a bar in such a manner that this bar has been connected only to a flange. This also enables, for instance, a good accessibility of the bars on the end faces. A connection of the bar to the outer ring is made in the region of tooth gaps in the flange of the inner ring. This is represented in FIG. 3, for instance.

1-17. (canceled)

18. A squeeze film damper, comprising:
an inner ring;
an outer ring; and
a plurality of bars designed to connect the inner ring and the outer ring,
wherein at least one of the inner and outer rings comprises a flange, with individual ones of the plurality of bars being connected only to the flange.

19. The squeeze film damper of claim 18, wherein the inner ring and the outer ring are capable of being axially braced relative to one another and/or capable of being variably positioned by the bars, and/or wherein different ones of the bars or groups of the bars are connected alternately to different flanges.

20. The squeeze film damper of claim 18, wherein the inner ring is braced relative to the outer ring by the bars.

21. The squeeze film damper of claim 18, wherein the inner ring is axially braced relative to the outer ring by the bars.

22. The squeeze film damper of claim 18, wherein at least one of the inner and outer rings is an open ring or a closed ring, wherein, when the at least one of the inner and outer rings is the open ring, the open ring is capable of being joined together to form a closed ring.

23. The squeeze film damper of claim 18, wherein at least one of the inner and outer rings is capable of being divided.

24. The squeeze film damper of claim 18, wherein a first number of the plurality of bars is designed to pull the outer ring in a first axial direction of tension, and a second number of the plurality of bars is designed to pull the outer ring in a second axial direction of tension, wherein bars of the plurality of bars or groups of bars of the plurality of bars that have different directions of tension alternate.

25. The squeeze film damper of claim 18, wherein the bars comprise each a surface layer.

26. The squeeze film damper of claim 18, wherein the bars are made of different materials.

27. The squeeze film damper of claim 18, wherein the inner ring has a U-shaped profile, with the outer ring being designed to protrude at least partly into the U-shaped profile of the inner ring, or wherein the outer ring has a U-shaped profile, with the inner ring designed to protrude at least partly into the U-shaped profile of the outer ring,

28. The squeeze film damper of claim 18, wherein the squeeze film damper is provided for a bearing.

29. The squeeze film damper of claim 28, wherein the bearing is a slide bearing.

30. The squeeze film damper of claim 18, designed for integration into a bearing housing.

31. The squeeze film damper of claim 19, wherein a bracing of the Inner ring and the outer ring is capable of being adapted.

32. The squeeze film damper of claim 18, wherein at least one of the plurality of bars is capable of being exchanged, and/or wherein at least one of the plurality of bars has a spring action.

33. An electric machine, comprising:
a first bearing; and
a second bearing,
wherein at least one of the first and second bearings comprises the squeeze film damper of claim 18,

34. A method for creating a squeeze film damper, the method comprising bracing and/or variably positioning elements of the squeeze film damper, with a first one of the elements being an inner ring, and a second one of the elements being an outer ring.

35. The method of claim 34, further comprising:
connecting the inner ring and the outer ring by a plurality of bars; and
for changing a spring action, exchanging at least one of the bars and/or changing a prestressing and/or an effective length of the bars.

36. The method of claim 34, further comprising connecting individual ones of the plurality of bars to only a flange of at least one of the inner and outer rings.
